(19) United States
(12) Patent Application Publication
(10) Pub. No.: US 2014/0009658 A1
(43) Pub. Date: Jan. 9, 2014

(54) IMAGE COMPOSITION APPARATUS, CONTROL METHOD THEREFOR, AND STORAGE MEDIUM STORING CONTROL PROGRAM THEREFOR

(71) Applicant: Canon Kabushiki Kaisha, Tokyo (JP)

(72) Inventor: Yuki YOSHIMURA, Tokyo (JP)

(21) Appl. No.: 13/929,974

(22) Filed: Jun. 28, 2013

(30) Foreign Application Priority Data
Jul. 3, 2012 (JP) 2012-149491

(51) Int. Cl. H04N 5/235

(52) U.S. Cl. CPC H04N 5/2353
USPC 348/333.01; 348/365; 348/345

(57) ABSTRACT

An image composition apparatus that is capable of obtaining a good movie with a smooth movement when composite images each of which is obtained by composing images taken with short exposure time is reproduced as a movie. An exposure control unit calculates a proper exposing condition of a subject based on continuously taken images. A reproducing image selection unit selects temporally discrete images of which the number corresponds to the proper exposing condition from the taken images. A reproducing image composition unit composes the images selected by the reproducing image selection unit to generate a composite image.

### BACKGROUND OF THE INVENTION

1. Field of the Invention

The present invention relates to an image composition apparatus, which composes continuously taken images to form one image, a control method therefor, and a storage medium storing a control program therefore.

2. Description of the Related Art

Generally, a large aperture and long exposure time are required to take a dark subject. On the other hand, there is a known image taking apparatus that takes a dark subject multiple times with short exposure time and forms one image by composing the taken images (see Japanese Laid-Open Patent Publication (Kokai) No. 2006-174069 (JP 2006-174069A)).

When images are taken multiple times with short exposure time and are composed into one image as described in the above-mentioned publication, image deterioration due to camera shake etc. and signal saturation of an image pickup device are avoidable.

However, when composite images are continuously reproduced as a movie, if partial continuous images among the images taken in one frame are composed, the composite image is greatly different from images of the adjacent frames, which fails to obtain a smooth movie and lowers its quality.

### SUMMARY OF THE INVENTION

The present invention provides an image composition apparatus, a control method therefor, and a storage medium storing a control program therefor, which are capable of obtaining a good movie with a smooth movement when composite images each of which is obtained by composing images taken with short exposure time are reproduced as a movie.

Accordingly, a first aspect of the present invention provides an image composition apparatus comprising an exposure control unit configured to calculate a proper exposing condition of a subject based on continuously taken images, a reproducing image selection unit configured to select temporally discrete images of which the number corresponds to the proper exposing condition from the taken images, and a reproducing image composition unit configured to compose the images selected by the reproducing image selection unit to generate a composite image.

Accordingly, a second aspect of the present invention provides an image composition apparatus comprising a composition unit configured to compose target images among continuously taken images, a display unit configured to continuously display composite images generated by the composition unit, and a calculation unit configured to calculate an evaluation value used for determining an exposing condition based on the composite image generated by the composition unit. The composition unit composes discrete target images among the taken images when the composite images are continuously displayed on the display unit. The composition unit composes continuous target images among the taken images when the composite image is used for calculating the evaluation value.

Accordingly, a third aspect of the present invention provides an image composition apparatus comprising a composition unit configured to compose target images among continuously taken images, a recording unit configured to record composite images generated by the composition unit as a movie, and a calculation unit configured to calculate an evaluation value used for determining an exposing condition based on the composite image generated by the composition unit. The composition unit composes discrete target images among the taken images when the composite images are recorded as a movie by the recording unit. The composition unit composes continuous target images among the taken images when the composite image is used for calculating the evaluation value.

According to the present invention, a good movie with a smooth movement is acquired when composite images each of which is obtained by composing images taken with short exposure time are reproduced as a movie.

Further features of the present invention will become apparent from the following description of exemplary embodiments with reference to the attached drawings.

### BRIEF DESCRIPTION OF THE DRAWINGS

FIG. 1 is a view showing a configuration of an image pickup apparatus (camera) that is provided with an image composition apparatus according to an embodiment of the present invention.

FIG. 2 is a view showing a mechanism of a reproducing image composition process executed by the camera shown in FIG. 1.

FIG. 3A is a view showing an image selection method when two images are composed in a reproducing image selection process executed by a reproducing image selection unit shown in FIG. 1.

FIG. 3B is a view showing an image selection method when three images are composed in the reproducing image selection process executed by the reproducing image selection unit shown in FIG. 1.

FIG. 4 is a view showing a mechanism of an evaluation image selection process executed by an evaluation image selection unit shown in FIG. 1.

FIG. 5 is a block diagram schematically showing a circuit configuration used for the reproducing image composition process in the camera shown in FIG. 1.

FIG. 6 is a flowchart showing the reproducing image composition process in the camera shown in FIG. 1.

FIG. 7 is a flowchart showing an evaluation image composition process in the camera shown in FIG. 1.

### DESCRIPTION OF THE EMBODIMENTS

Hereafter, embodiments according to the present invention will be described in detail with reference to the drawings.

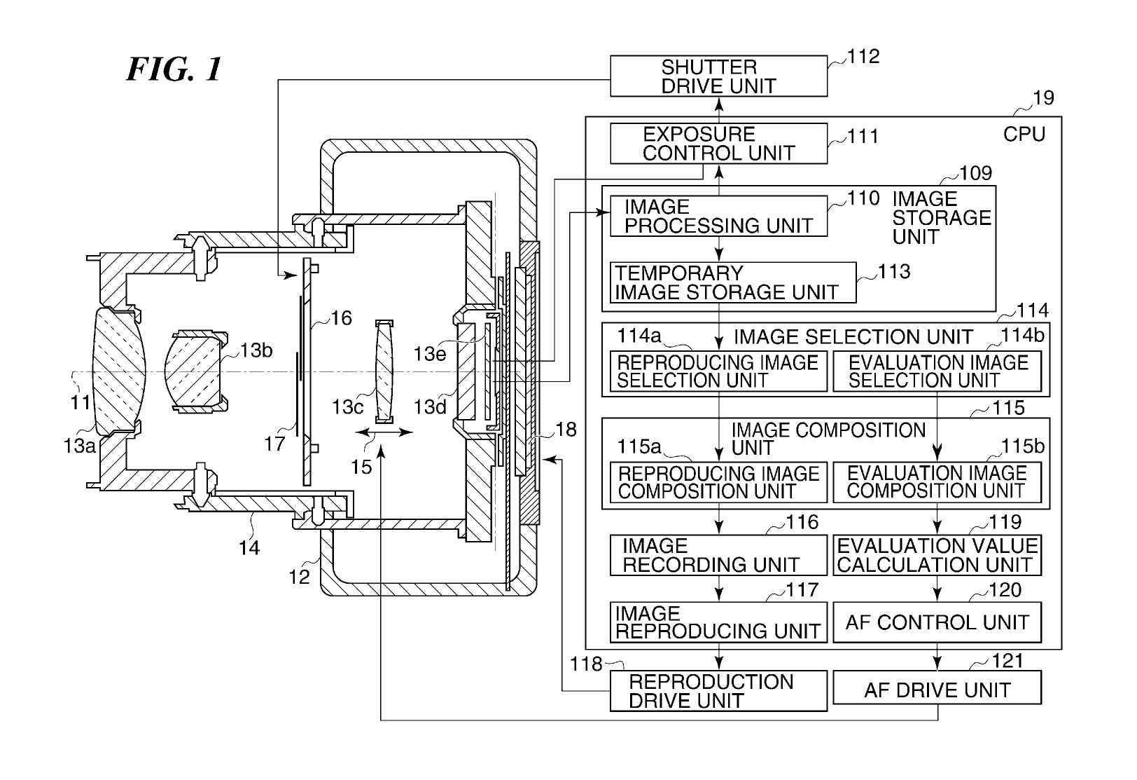

FIG. 1 is a view showing a configuration of an image pickup apparatus that is provided with an image composition apparatus according to an embodiment of the present invention.

The image pickup apparatus shown in FIG. 1 is a digital still camera (referred to as a camera, hereafter), for example, and has a camera body 12 and a control unit (referred to as a CPU, hereafter) 19. The camera body 12 is provided with an image pickup optical system, which is supported with a lens barrel 14.

The image pickup optical system is provided with a first lens 13a, a second lens 13b, a third lens 13c, and an optical low pass filter 13d. An image pickup device 13e is arranged on an optical axis 11 of the image pickup optical system. Here, a taking lens unit is a general name for the first lens 13a, the second lens 13b, and the third lens 13c. The third lens 13c is driven by an AF drive unit 121 along the optical axis 11 as shown by a solid line arrow 15.

A shutter 16 having shutter blades 17 is arranged between the second lens 13b and the third lens 13c. The shutter 16 is driven by a shutter drive unit 112 so as to open the shutter blades 17 during exposure time to guide an incident light to the image pickup device 13e through the taking lens unit and the optical low pass filter 13d.

As a result of this, an optical image is formed on the image pickup device 13e, and the image pickup device 13e outputs an electrical signal (analog signal) corresponding to the optical image. Then, this analog signal is given to an image processing unit 110 mentioned later. It should be noted that a liquid crystal display monitor 18 as a display unit is arranged at the back side of the camera body 12.

As shown in FIG. 1, the CPU 19 has an exposure control unit 111, the image processing unit 110, a temporary image storage unit 113, an image selection unit 114, an image composition unit 115, an image recording unit 116, an evaluation value calculation unit 119, an image reproducing unit 116, and an AF control unit 120. The exposure control unit 111 is connected to the shutter drive unit 112, and drives the shutter 16 by controlling the shutter drive unit 112 as mentioned later.

Moreover, the AF control unit 120 controls an AF drive unit 121, and drives the third lens 13c by controlling the AF drive unit 121 as mentioned later. The image reproducing unit 117 is connected to the liquid crystal display monitor 18 through a reproduction drive unit 118.

Although the CPU 19 etc. are actually built in the camera body 12, they are illustrated outside the camera body 12 in FIG. 1 for the convenience of description.

The image processing unit 110 receives the analog signal outputted from the image pickup device 13e, and converts the analog signal concerned into a digital signal. Then, the image processing unit 110 applies a predetermined image process to the digital signal, and acquires image data. This image data is once recorded in the temporary image storage unit 113. It should be noted that the image processing unit 110 and the temporary image storage unit 113 constitutes an image storage unit 109. Moreover, the image processing unit 110 generates subject information that shows brightness of a subject image, etc. based on the image data.

The exposure control unit 111 controls an exposing condition of an optical image formed on the image pickup device 13e, and makes the shutter blade 17 open and close by controlling the shutter drive unit 112. Specifically, the exposure control unit 111 receives the subject information from the image processing unit 110, and sets the exposure time for taking a still image or a movie according to the subject information concerned.

When a still image is taken, the exposure control unit 111 opens the shutter blade 17 according to the exposure time (exposing condition). As a result of this, an incident light through the taking lens unit forms an image on the image pickup device 13e, and the image pickup device 13e gives an analog signal to the image processing unit 113 as mentioned above.

When a movie is taken, the exposure control unit 111 controls an electronic shutter function of the image pickup device 13e according to the exposing condition, and keeps the shutter blade 17 open during the movie taking. That is, the exposure control unit 111 updates an image with appropriate exposure at a predetermined frame rate (for example, 1/30 seconds). Moreover, when a movie is taken, the image data (images) within one frame processed by the image processing unit 110 is temporarily recorded in the temporary image storage unit 113.

The image selection unit 114 is provided with a reproducing image selection unit 114a and an evaluation image selection unit 114b. The reproducing image selection unit 114a selects temporally discrete images from the image data recorded in the temporary image storage unit 113 according to the exposing condition set by the exposure control unit 111. The evaluation image selection unit 114a selects temporally continuous images from the image data recorded in the temporary image storage unit 113 according to the exposing condition suitable for an AF evaluation set by the exposure control unit 111.

The image composition unit 115 is provided with a reproducing image composition unit 115a and an evaluation image composition unit 115b. The reproducing image composition unit 115a composes the images (target images) selected by the reproducing image selection unit 114a, and generates a reproducing composite image.

Since the images differ in the taking timing, the image deviation may occur due to a camera shake and a subject motion. Accordingly, the reproducing image composition unit 115a performs a composition process after aligning the images to avoid the image deviation among the images with a well-known technique.

The evaluation image composition unit 115b composes the images (target images) selected by the evaluation image selection unit 114b, and generates an evaluation image for the AF evaluation. Since the images differ in the taking timing, the image deviation may occur due to a camera shake and a subject motion. Accordingly, the evaluation image composition unit 115b performs a composition process after aligning the images to avoid the image deviation among the images with a well-known technique.

The reproducing composite image that is outputted from the reproducing image composition unit 115a is recorded in the image recording unit 116 as a recorded image. The image reproducing unit 117 controls the reproduction drive unit 118 according to a user's operation so as to reproduce the recorded image and to display it on the liquid crystal display monitor 18.

The evaluation image that is outputted from the evaluation image composition unit 115b is given to the evaluation value calculation unit 119. The evaluation value calculation unit 119 calculates a contrast evaluation value (an evaluation value for focusing) according to the evaluation image.

The AF control unit 120 controls the AF drive unit 121 according to the contrast evaluation value to move the third lens 13c in the direction of the solid line arrow 15 (i.e., the direction of the optical axis) to focus on a subject.

The method for selecting images used for the AF evaluation is different from the method for selecting images used for reproducing. The former method may be used for calculating the proper exposing condition of a subject as the exposure control or for detecting a subject within an image. The evaluation value calculation unit 119 calculates a Bv value etc., for example, as an evaluation value for controlling exposure, and calculates a subject position and its reliability by a well-known subject detection process, such as a pattern matching, as an evaluation value for detecting a subject.

Next, how to generate the composite image used for displaying and recording will be described.

If there is a great image difference between frames, the images that are reproduced continuously (they are referred to as reproducing images, hereafter) will give a user an impression like what is called a flip animation. That is, when the images are reproduced continuously, the quality of the movie will deteriorate. On the other hand, images that a viewer feels a continuous relation are of high quality as a movie even if they are slightly blurred.

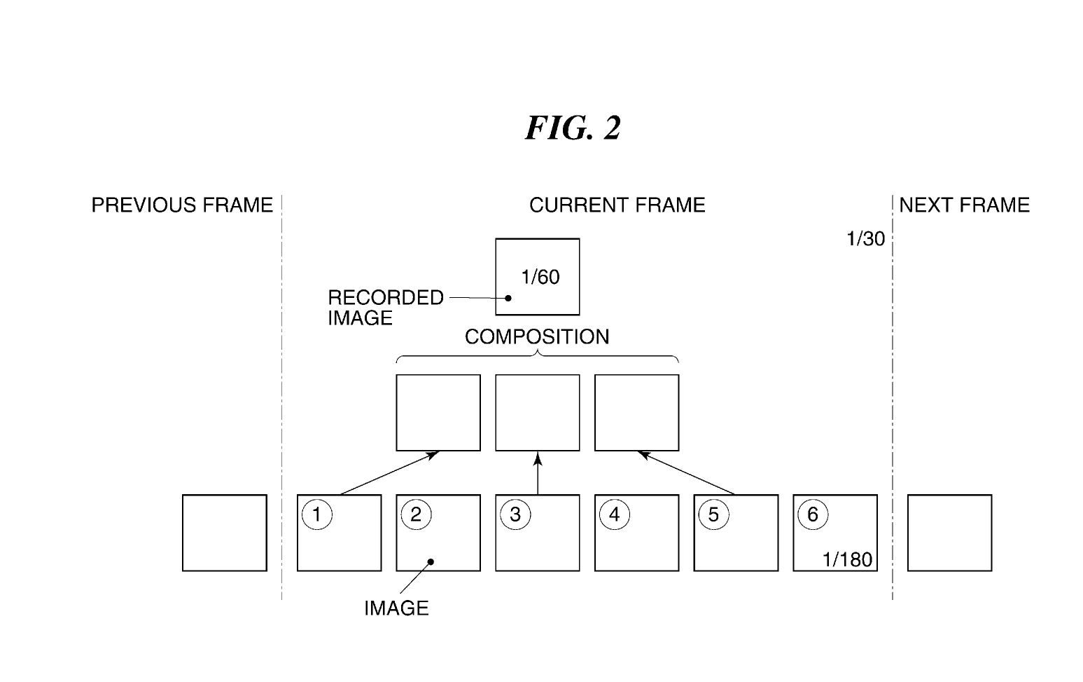

FIG. 2 is a view showing a mechanism of a reproducing image composition process executed by the camera shown in FIG. 1.

In the example shown in FIG. 2, the camera sets a first exposure time (shutter speed) that is an exposure time for taking one image as 1/180 seconds, and acquires six images continuously using the same exposure time within one frame ( 1/30 seconds).

Since one frame is divided into six sections, the images with little effect of camera shake can be acquired by increasing shutter speed. Then, these images are aligned and composed.

The reproducing image selection unit 114a selects temporally discrete images of which the number corresponds to the proper exposing condition of the subject from the images stored in the temporary image storage unit 113. For example, when the proper exposing condition (a second exposure time) is 1/60 seconds, the reproducing image selection unit 114a selects three images stored in the temporary image storage unit 113 because three times the first exposure time is the second exposure time. In order to reduce the image difference between the current frame and the previous and next frames, the first image, the third image, and the fifth image on a time-series basis are selected from the six images in the current frame.

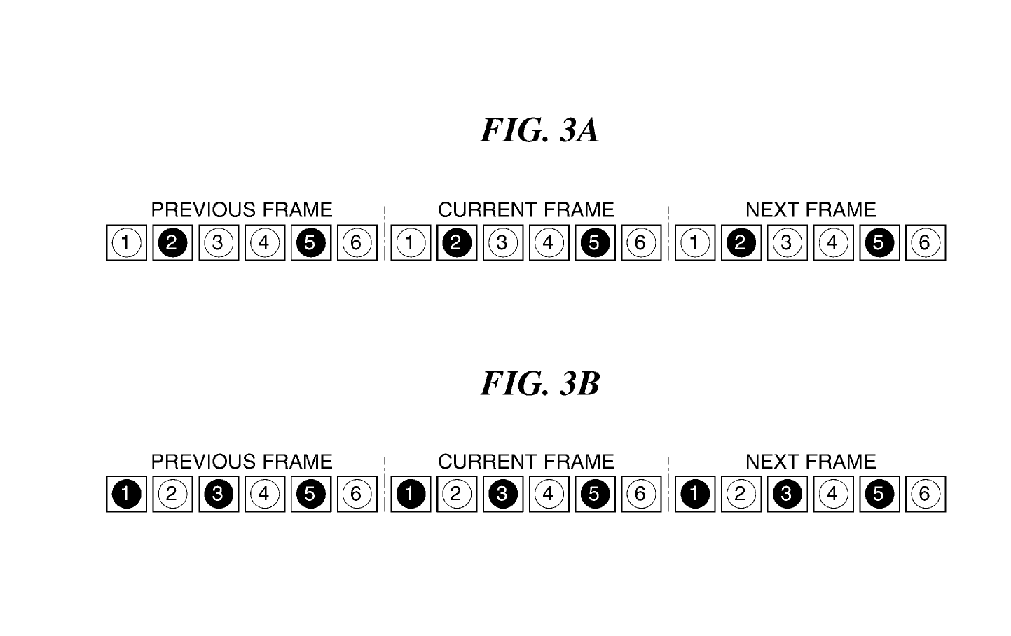

FIG. 3A is a view showing a reproducing image selection method when two images are composed in an image selection process executed by the reproducing image selection unit 114a shown in FIG. 1. FIG. 3B is a view showing an image selection method when three images are composed in the reproducing image selection process executed by the reproducing image selection unit 114a shown in FIG. 1. The six images are included in each frame, and a selected image is indicated by a white numeral in a black circle.

As shown in FIG. 3A, when two images are composed in each frame (two times the first exposure time is the second exposure time), the reproducing image selection unit 114a selects the second and fifth images. As shown in FIG. 3B, when three images are composed in each frame (three times the first exposure time is the second exposure time), the reproducing image selection unit 114a selects the first, third and fifth images. Thus, the images selected are changed according to the relation between the first exposure time and the second exposure time. This reduces an impression like what is called a flip animation when composite images are continuously reproduced.

On the other hand, an image with minimum blur is required as an evaluation image that is used for the AF evaluation. This is a difference from a reproducing image. Accordingly, when the evaluation image is generated, the temporally continuous images of the predetermined number are selected from images taken within one frame. Then, the selected images concerned are aligned and composed. The number of images to be selected may be fixed or may be set corresponding to a proper exposing condition of a subject.

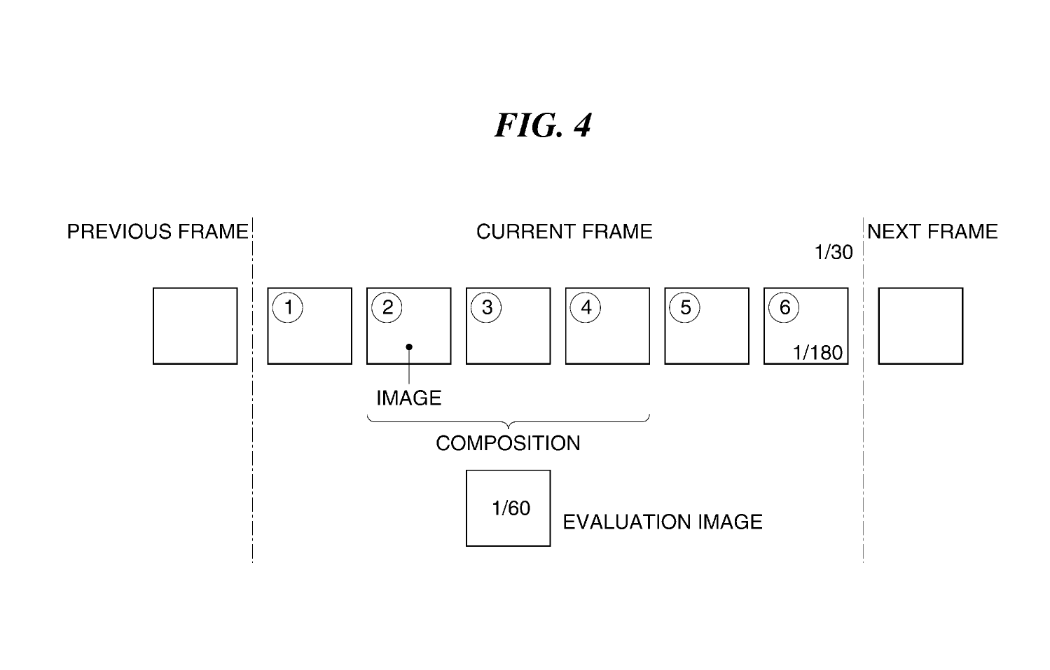

FIG. 4 is a view showing a mechanism of an evaluation image selection process executed by the evaluation image selection unit 114b shown in FIG. 1.

As shown in FIG. 4, when the exposing condition is 1/60 seconds and the shutter speed is 1/180 seconds, three images are necessary to generate a composite image. Accordingly, the evaluation image selection unit 114b selects the second, third, and fourth images on a time-series basis from the images within the current frame stored in the temporary image storage unit 113. Then, the evaluation image composition unit 115b aligns and composes the selected images to generate an evaluation image.

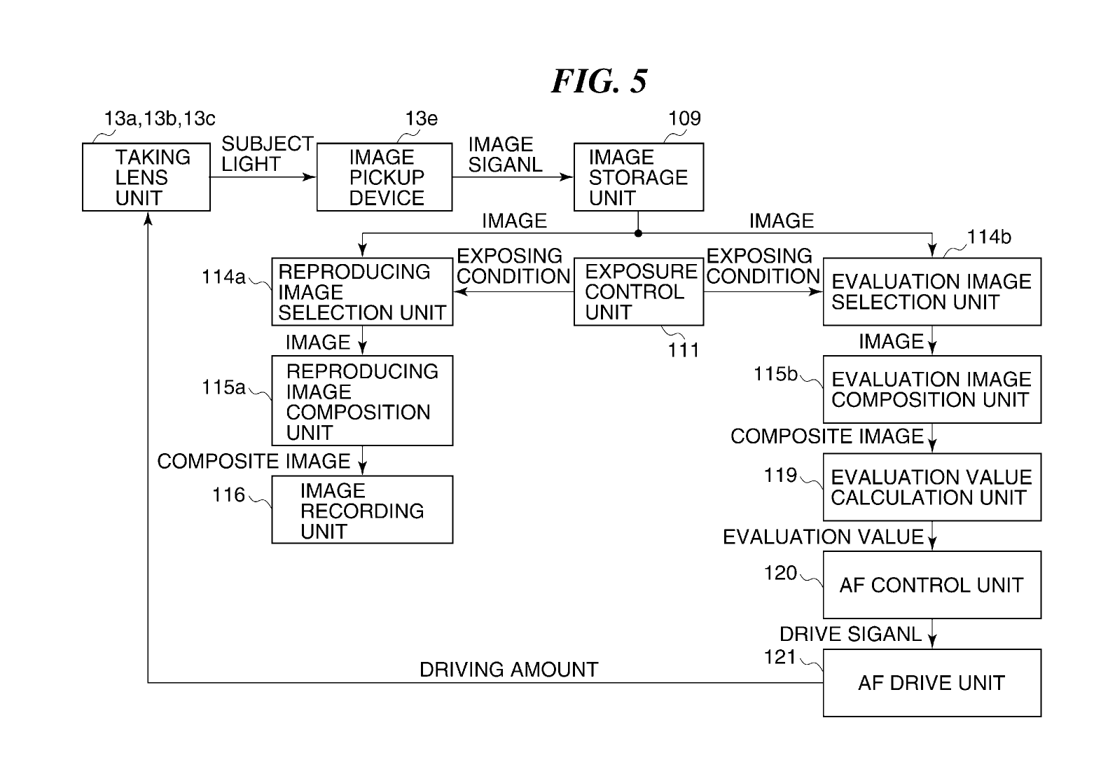

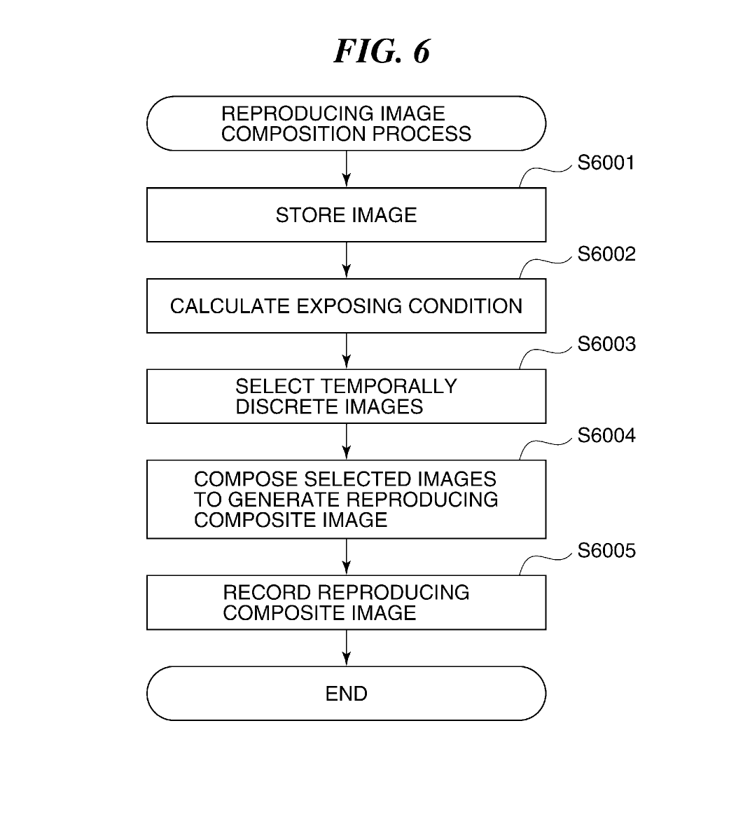

FIG. 5 is a block diagram schematically showing a circuit configuration used for the reproducing image composition process in the camera shown in FIG. 1. FIG. 6 is a flowchart showing the reproducing image composition process in the camera shown in FIG. 1.

The reproducing image composition process will be described with reference to FIG. 5 and FIG. 6. The image pickup device 13e receives an optical image formed through the lenses 13a, 13b, and 13c, and outputs an analog signal (an image signal) corresponding to the optical image. The image storage unit 109 applies a predetermined image process to the image signal, and stores it as image data (images) in step S6001. After the image data is stored in the image storage unit 109, the exposure control unit 111 calculates an exposing condition as mentioned above based on the subject information in the image data (step S6002).

The reproducing image selection unit 114a selects temporally discrete images of which the number corresponds to the proper exposing condition of the subject acquired from the exposure control unit 111 from the images within one frame stored in the temporary image storage unit 113 (step S6003). That is, the reproducing image selection unit 114a determines the number of images to be composed so that the total exposure time of the selected images matches the exposure time corresponding to the proper exposing condition. The reproducing image composition unit 115a aligns and composes the images selected by the reproducing selection unit 114a, and generates a reproducing composite image (step S6004). Then, the image recording unit 116 records the reproducing composite image (step S6005), and finishes the reproducing image composition process.

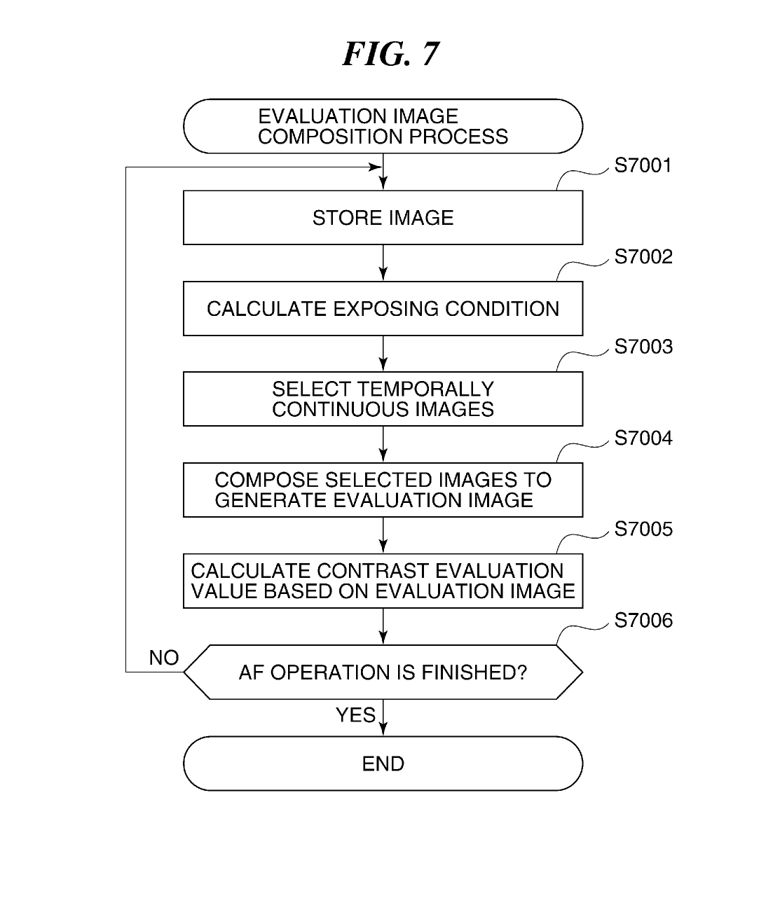

FIG. 7 is a flowchart showing an evaluation image composition process in the camera shown in FIG. 1.

The evaluation image composition process will be described with reference to FIG. 5 and FIG. 7. As mentioned above, the image storage unit 109 applies the image process to the image signal that is outputted from the image pickup device 13e, and then, stores the processed image signal as image data (images) in step S7001. After the image data is stored in the image storage unit 109, the exposure control unit 111 calculates an exposing condition as mentioned above based on the subject information in the image data (step S7002).

The evaluation image selection unit 114b selects the temporally continuous (adjacent) images of the predetermined number from the images within one frame stored in the image storage unit 109 based on the exposing condition acquired from the exposure control unit 111 (step S7003). The evaluation image composition unit 115b aligns and composes the images selected by the evaluation image selection unit 114b, and generates an evaluation image (step S7004). Then, the evaluation value calculation unit 119 calculates a contrast evaluation value based on the evaluation image outputted by the evaluation image composition unit 115b (step S7005).

Next, the AF control unit 120 generates and outputs a driving signal based on the contrast evaluation value. The AF drive unit 121 generates the driving amount according to the driving signal, and drives the third lens 13c in the optical axis direction.

The AF control unit 120 determines whether an AF operation is finished based on the contrast evaluation value (step S7006). Then, when the AF control unit 120 determines that the AF operation is finished (YES in the step S7006), the evaluation image composition process is finished.

On the other hand, when the AF control unit 120 determines that the AF operation is not finished (NO in the step S7006), the process returns to the step S7001.

Since the embodiment of the present invention periodically acquires images with short exposure time within one frame, selects discrete images of the predetermined number from the acquired images, and composes the selected images, the images can be smoothly and stably reproduced when the composite images are continuously reproduced.

Although the embodiments of the invention have been described, the present invention is not limited to the above-mentioned embodiments, the present invention includes various modifications as long as the concept of the invention is not deviated.

For example, the function of the above mentioned embodiment can be achieved as a control method that is executed by the image composition apparatus. Moreover, the function of the above mentioned embodiment may be achieved as a control program that is executed by a computer with which the image composition apparatus is provided. It should be noted that the control program is recorded into a computer-readable storage medium, for example.

Each of the control method and the control program includes at least an exposure value calculation step, a reproducing image selection step, and a reproducing image composition step.

The present invention may be accomplished by executing the following process. That is, the process supplies software (a program) that achieves the function of the above described embodiment to a system or an apparatus via a network or a recording medium, and makes a computer (or CPU or MPU) of the system or the apparatus read and execute the program.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-149491, filed on Jul. 3, 2012, which is hereby incorporated by reference herein in its entirety.

What is claimed is:

1. An image composition apparatus comprising:
an exposure control unit configured to calculate a proper exposing condition of a subject based on continuously taken images;
a reproducing image selection unit configured to select temporally discrete images of which the number corresponds to the proper exposing condition from the taken images; and
a reproducing image composition unit configured to compose the images selected by said reproducing image selection unit to generate a composite image.

2. The image composition apparatus according to claim 1, wherein the taken images are continuously taken using the same exposure time.

3. The image composition apparatus according to claim 1, wherein said reproducing image selection unit selects images so that the total exposure time of the selected images matches the exposure time corresponding to the proper exposing condition.

4. The image composition apparatus according to claim 1, further comprising:
an image recording unit configured to record the composite image that is composed by said reproducing image composition unit; and
an image reproducing unit configured to display the composite image recorded in said image recording unit onto a display unit in response to a user's operation.

5. The image composition apparatus according to claim 1, further comprising:
an evaluation image selection unit configured to select temporally continuous images from the taken images;
an evaluation image composition unit configured to compose the images selected by said evaluation image selection unit to generate an evaluation image; and
an evaluation value calculation unit configured to calculate an evaluation value based on the evaluation image.

6. The image composition apparatus according to claim 5, wherein the evaluation value is used for focusing.

7. The image composition apparatus according to claim 6, further comprising:
a focusing unit configured to drive a taking lens to focus on a subject based on the evaluation value calculated by said evaluation value calculation unit.

8. The image composition apparatus according to claim 5, wherein the evaluation value is used for calculating a proper exposing condition of a subject.

9. The image composition apparatus according to claim 5, wherein the evaluation value is used for detecting a subject within an image.

10. A control method for an image composition apparatus comprising:
an exposure control step of calculating a proper exposing condition of a subject based on continuously taken images;
a reproducing image selection step of selecting temporally discrete images of which the number corresponds to the proper exposing condition from the taken images; and
a reproducing image composition step of composing the images selected in said reproducing image selection step to generate a composite image.

11. A non-transitory computer-readable storage medium storing a control program causing a computer to execute a control method for an image composition apparatus, the control method comprising:
an exposure control step of calculating a proper exposing condition of a subject based on continuously taken images;
a reproducing image selection step of selecting temporally discrete images of which the number corresponds to the proper exposing condition from the taken images; and
a reproducing image composition step of composing the images selected in said reproducing image selection step to generate a composite image.

12. An image composition apparatus comprising:
a composition unit configured to compose target images among continuously taken images;
a display unit configured to continuously display composite images generated by said composition unit; and
a calculation unit configured to calculate an evaluation value used for determining an exposing condition based on the composite image generated by said composition unit,
wherein said composition unit composes discrete target images among the taken images when the composite images are continuously displayed on said display unit,
wherein said composition unit composes continuous target images among the taken images when the composite image is used for calculating the evaluation value.

13. The image composition apparatus according to claim 12, further comprising:
an acquisition unit configured to acquires subject information;
wherein said composition unit composes target images selected based on the subject information acquired by said acquisition unit.

14. The image composition apparatus according to claim 13, wherein said composition unit composes the target images of which the number is determined based on the subject information among the taken images.

15. The image composition apparatus according to claim 13, wherein said composition unit composes target images selected so that exposure time determined based on the subject information becomes equal to the total exposure time of the target images.

16. The image composition apparatus according to claim 12, wherein said calculation unit calculates the evaluation value used for determining the exposing condition for continuously taking images based on the composite image.

17. The image composition apparatus according to claim 12, wherein the evaluation value is used for one of focusing, determination of an exposure, and detection of a subject within an image.

18. An image composition apparatus comprising:
a composition unit configured to compose target images among continuously taken images;
a recording unit configured to record composite images generated by said composition unit as a movie; and
a calculation unit configured to calculate an evaluation value used for determining an exposing condition based on the composite image generated by said composition unit,
wherein said composition unit composes discrete target images among the taken images when the composite images are recorded as a movie by said recording unit,
wherein said composition unit composes continuous target images among the taken images when the composite image is used for calculating the evaluation value.

19. An image composition apparatus comprising:
a composition unit configured to compose target images among continuously taken images;
a display unit configured to continuously display composite images generated by said composition unit; and
a calculation unit configured to calculate an evaluation value used for determining an exposing condition based on the composite image generated by said composition unit,
wherein temporal discreteness of the target images in the case when the composite images are continuously displayed on said display unit is larger than that in the case when the composite image is used for calculating the evaluation value.

20. An image composition apparatus comprising:
a composition unit configured to compose target images among continuously taken images;
a recording unit configured to record composite images generated by said composition unit as a movie; and
a calculation unit configured to calculate an evaluation value used for determining an exposing condition based on the composite image generated by said composition unit,
wherein temporal discreteness of the target images in the case when the composite images are recorded as a movie by said recording unit is larger than that in the case when the composite image is used for calculating the evaluation value.
